(19) United States
(12) Patent Application Publication
(10) Pub. No.: US 2026/0312866 A1
(43) Pub. Date: Oct. 8, 2026

(54) METHODS AND SYSTEMS FOR UNIVERSAL IOT DEVICE INTEGRATION

(71) Applicant: Panasonic Well LLC, Palo Alto, CA (US)

(72) Inventor: Ramin Firoozye, San Francisco, CA (US)

(21) Appl. No.: 19/276,842

(22) Filed: Jul. 22, 2025

Related U.S. Application Data
(60) Provisional application No. 63/783,822, filed on Apr. 4, 2025.

(51) Int. Cl. H04L 41/0806; G16Y 40/35; H04L 9/40

(52) U.S. Cl. CPC H04L 41/0806; G16Y 40/35; H04L 63/101

(57) ABSTRACT

Disclosed embodiments may provide techniques for provisioning and interacting with devices deployed within an Internet-of-Things (IoT) network environment. A computer-implemented method can include receiving a request to provision a device in an Internet-of-Things (IoT) network environment. The computer-implemented method can also include accessing configuration data associated with the device. In some instances, the configuration data includes one or more device attributes indicating how the device operates and interacts within the IoT network environment. The computer-implemented method can also include determining a set of user-interface components based on the configuration data. The computer-implemented method can also include generating a particular user interface based on the set of user-interface components. The computer-implemented method can also include loading the particular user interface on an adaptive interface application, in which the one or more operations of the device can be initiated by interacting with the particular user interface of the adaptive interface application.

### CROSS-REFERENCES TO RELATED APPLICATIONS

The present patent application claims the priority benefit of U.S. provisional patent application number 63/783,822 filed Apr. 4, 2025 and is related is related to U.S. Patent Applications entitled “ABILITY-BASED USER INPUT INTERFACE” (POL Ref. 109304-845007-008900US) filed Jul. 22, 2025 and “MULTI-MODAL INTERACTION FOR PEOPLE WITH DISABILITY” (POL Ref. 109304-845017-009000US) filed Jul. 22, 2025, U.S. Provisional Application 63/783,813 filed Apr. 4, 2025 entitled “ABILITY-BASED USER INPUT INTERFACE” and U.S. Provisional Application 63/783,817 filed Apr. 4, 2025 entitled “MULTI-MODAL INTERACTION FOR PEOPLE WITH DISABILITY”, the disclosures of which are incorporated herein by reference in its entirety for all purposes.

### FIELD

The present disclosure relates generally to provisioning and interacting with devices deployed within an Internet-of-Things (IoT) network environment. In one example, the systems and methods described herein may be used to generate customized user interfaces for a device within the IoT network environment.

### SUMMARY

Disclosed embodiments may provide techniques for provisioning and interacting with devices deployed within an Internet-of-Things (IoT) network environment. A computer-implemented method can include receiving a request to provision a device in an Internet-of-Things (IoT) network environment. The computer-implemented method can also include accessing configuration data associated with the device. In some instances, the configuration data includes one or more device attributes indicating how the device operates and interacts within the IoT network environment. The computer-implemented method can also include determining a set of user-interface components based on the configuration data. The computer-implemented method can also include calibrating parameters associated with the set of user-interface components based on user ability data. The computer-implemented method can also include generating a particular user interface for the device.

In some instances, the particular user interface is generated based on the set of user-interface components and calibrated parameters, in which the particular user interface is different from user interfaces associated with other devices within the IoT network environment. The computer-implemented method can also include loading the particular user interface on an adaptive interface application. The computer-implemented method can also include deploying the device into the IoT network environment. The one or more operations of the device can be initiated by interacting with the particular user interface of the adaptive interface application.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates a schematic diagram of provisioning IoT devices in an IoT network environment, according to some embodiments.

FIG. 2 shows an illustrative example of a process for provisioning IoT devices in an IoT network environment, in accordance with some embodiments.

FIG. 3 illustrates a schematic diagram for mapping various types of inputs to operations of IoT devices, according to some embodiments.

FIG. 4 shows an illustrative example of a process for mapping various types of inputs to operations of IoT devices, in accordance with some embodiments.

FIG. 5 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. Provisioning Devices Within a Universal IoT Mobile Interaction System

Existing Internet-of-Things (IoT)-based systems rely on a tight integration between devices and mobile applications, in which the mobile applications are used to observe and control the devices. This integration includes not only the communication protocols that facilitate seamless data exchange but also the user interface (UI) and user experience (UX) considerations specific to each device. For example, a smart thermostat may use Bluetooth Low Energy (BLE) or Wi-Fi to communicate with a smartphone app, which provides a touch-based UI with options for adjusting temperature, scheduling, and monitoring energy usage. Similarly, a smart security camera may leverage a mobile app to provide live video streaming, motion alerts, and cloud storage access, ensuring users have full control over its functionalities.

These IoT-based systems extend their capabilities beyond mobile devices and run on various platforms, including gateway devices, tablets, television sets, smart assistants, or any device capable of receiving user input and providing output. These platforms, collectively referred to as “interfaces,” are not limited to a specific form factor. For example, a smart home hub with a touchscreen could serve as an interface for controlling lights, locks, and appliances. In another example, a voice assistant, such as Amazon Alexa or Google Assistant, can provide hands-free interaction with IoT devices through voice commands. In yet another example, augmented reality (AR) glasses or wearables could function as interfaces, allowing users to interact with their environment using gesture-based controls or visual overlays.

The present techniques provide an adaptive interface application can be configured to operate without requiring a predefined, tightly bound relationship with individual devices in terms of communication protocols or UI/UX structures. Instead of relying on preinstalled drivers or manually configured apps, the adaptive interface application dynamically learns how to interact with new devices as it encounters them. For example, when a user introduces a new smart light bulb into their home, the adaptive interface application would automatically detect the device, initiate a discovery process, and generate a suitable user interface for controlling its brightness, color temperature, or scheduling features. This eliminates the need for users to install specific apps for each new device or manually update software drivers, thus streamlining the overall user experience.

This adaptive capability may leverage ongoing communication standardization efforts, such as Zigbee, Z-Wave, BLE, Wi-Fi, HomeKit, Thread, Matter protocols, as well as wired protocols like Ethernet, RS-232, or CANBus, which provide interoperability frameworks for smart home and IoT devices. However, the adaptive interface application extends beyond these standards, allowing it to function as an abstraction layer that integrates with any device, regardless of its native communication protocol. For example, while Matter aims to unify smart home device compatibility, the adaptive interface application could go further by integrating legacy devices that do not support Matter, using machine learning or predefined heuristics to map their functionalities dynamically.

The mode of interaction is not limited to mobile applications but can include a diverse range of input mechanisms, such as voice control, gesture recognition, or other interaction models defined separately via a user-interaction system (e.g., AbleUI). For instance, a user may raise their hand to dim the lights, issue a voice command to lock the doors, or use an adaptive touchscreen interface that reorganizes itself based on the available connected devices. By supporting multiple interaction paradigms, the interface ensures accessibility and usability across various contexts, allowing users to interact with their IoT ecosystem in a seamless, intuitive manner.

### A. Computing Environment

### 1. Discovery

The adaptive interface application performs a series of provisioning or setup steps to ensure its seamless integration into the existing IoT network environment. An IoT network environment can be a localized system of interconnected IoT devices that communicate and share data over wireless or wired protocols within a defined space, such as a home, office, or industrial site. The IoT network environment can include sensors, actuators, controllers, and networking components that are orchestrated through centralized or distributed control systems. The IoT network environment may also include connectivity to external cloud services or mobile applications (e.g., the adaptive interface application), allowing for real-time monitoring, configuration, and automation of device functions.

The adaptive interface application can be implemented on various types of devices that participate in or manage the IoT network environment. Examples of the device types can include but are not limited to a mobile device, a computing device, another IoT device, or a gateway device. For example, the gateway device(s) can be configured to operate as intermediaries between local IoT devices and external networks or cloud platforms, handling data aggregation, protocol translation, and access control. Additionally or alternatively, the adaptive interface application can be configured to operate in smart hubs, edge computing nodes, or specialized control units embedded within smart appliances, enabling flexible and adaptive user interaction across a range of device types.

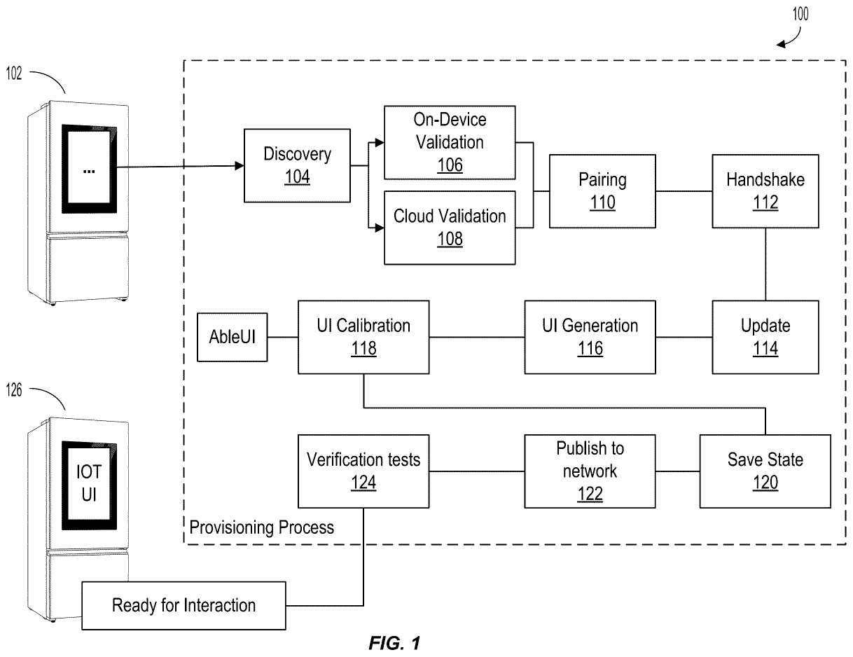

The provisioning process involves detecting the device, establishing communication, and configuring it for user interaction. FIG. 1 illustrates a schematic diagram 100 of provisioning IoT devices in an IoT network environment, according to some embodiments. As shown in FIG. 1, an adaptive interface application detects that an IoT device 102 is to be introduced into the IoT network environment. Examples of the IoT device 102 can include, but are not limited to, smart thermostats, connected lighting systems, environmental sensors, security cameras, smart locks, wearable health monitors, home automation hubs, connected appliances, vehicles, transportation mechanisms, accessibility accessories, wearables (health and non-health), entertainment and media devices, medical accessories and systems, cleaning and food preparation, toys, HVAC, security, and any device with sensors or controllable actuators.

The adaptive interface application initiates a discovery phase 104, during which the IoT device is placed into discovery mode,, allowing it to be detected by a nearby adaptive interface application (e.g., the adaptive interface application). The discovery phase 104 can include a process in which the adaptive interface application actively scans for and identifies compatible IoT devices within its communication range. During this phase, the IoT device broadcasts its presence and relevant metadata, such as device type, capabilities, or configuration status, typically using standardized protocols. In some instances, the IoT device can also broadcast using multiple types of broadcast mechanisms, for example alternating iBeacon BLE broadcasts with WiFi and BLE service broadcasts. For example, The iBeacon broadcast can be used to signal the user that a pairable device is nearby, and the app, when run, can scan for specific published characteristics. The discovery phase 104 ensures that the adaptive interface application can recognize the new IoT device 102 without requiring manual intervention from the user.

In some instances, the IoT device 102 may automatically enter the discovery mode when powered up and detecting that it has no pairing data. The automated initiation of the discovery mode does not require interaction to initiate discovery. In some instance, the IoT device 102 can already be paired and put into discovery mode to add another controlling device (e.g., another mobile device). The additional discovery mode can be initiated either by the IoT device 102 (e.g., through a pairing button or interface element), or by one or more devices of the IoT network environment that are already paired with the IoT device 102. In some instances, the discovery phase 104 may be re-applied when the IoT device 102 undergoes a post-shipping, firmware update (wired or wireless OTA). In this manner, the interface could be rearranged/re-learned if features of the IoT device 102 are extended after the first interaction.

Discovery phase 104 of the IoT device 102 can be facilitated through various communication modes, depending on the capabilities of the IoT device 102 and the available interface technologies in the environment. Many smart devices, such as fitness trackers, gateway devices, smartwatches, and wireless speakers, can use Bluetooth or Bluetooth Low Energy (BLE) for initial pairing. For instance, a smart lock might broadcast a Bluetooth signal that a smartphone app can detect, initiating the setup process. Zigbee and Z-Wave, which are low-power, mesh-networking protocols, are commonly used in smart home automation. A Zigbee-enabled smart light bulb, for example, can be discovered by the adaptive interface application as soon as it is powered on. Wi-Fi multicast is another method where devices that connect to Wi-Fi, such as smart cameras or thermostats, use multicast protocols to announce their presence on the IoT network environment. A smart thermostat may broadcast its availability, allowing the adaptive interface application to detect and initiate the provisioning process.

Some devices rely on visual identification methods, such as QR codes or barcodes, for discovery. A smart home security camera might include a QR code that users scan with a mobile app, providing authentication and configuration details. Others use NFC or RFID technologies for proximity-based discovery; for example, a smart access card reader may use NFC to detect and register new keycards.

Audio signals, both audible and ultrasonic, are another means of discovery. Some IoT devices 102 use sound waves to broadcast their presence, which can be detected by the adaptive interface application. A smart speaker may use this technique to identify and link additional speakers in a multi-room setup. Light-based signals, including infrared flashes, can also be employed. For instance, a television remote might send an infrared signal to synchronize with an entertainment hub.

In some instances, the IoT device 102 and the adaptive interface application exchange a set of identifiers that help classify the IoT device 102 during the discovery phase 104. These identifiers provide metadata, such as the device category, manufacturer details, model type, and supported capabilities. For example, when a smart thermostat is discovered, the device may communicate that it belongs to the climate control category, supports temperature and humidity monitoring, and is manufactured by a specific brand. This classification allows an appropriate control interface to be dynamically configured for the adaptive interface application.

### 2. Validation

After the discovery phase 104, the adaptive interface application can proceed with validation phase of the IoT device 102. During the validation phase, the adaptive interface application can obtain configuration data associated with the IoT device 102. The configuration data provides various information about how the IoT device 102 operates and interacts within the system. It can include version information, specifying both the firmware and hardware revisions to ensure compatibility. The configuration data may also define the available modes of communication, such as whether the device supports Bluetooth, Wi-Fi, Zigbee, Thread, Matter, or wired protocols such as Ethernet, RS-232, or CANBus (which may require an interface translator or gateway), or other networking standards. The supported protocols are outlined in the configuration data, indicating whether the device adheres to industry standards like MQTT, HTTP, Protobuf, Matter, or proprietary communication frameworks.

The configuration data can also specify the types of data points the device generates or accepts, such as temperature readings for a smart thermostat or motion detection alerts for a security camera. It includes validation rules and operational limits, ensuring that data inputs and outputs conform to expected ranges. Default values may also be provided, allowing the device to function immediately with preconfigured settings before customization.

Additionally or alternatively, the configuration data can include additional elements such as multimedia files, scripts, or metadata necessary to interact with the IoT device 102. The configuration data can also identify available endpoints, notifications, and operations, thus defining the device's capabilities for remote control, data retrieval, and event triggers.

In some instances, two possible pathways can be used for obtaining the configuration data. In a cloud validation phase 108, a type identifier of the IoT device 102 is securely transmitted to a remote server (e.g., a cloud computing environment), in which configuration data specific to a class associated with the IoT device 102 is retrieved and accessed by the adaptive interface application. In an on-device validation phase 106, the IoT device 102 is prompted to transmit the same configuration data directly to the adaptive interface application. Such local retrieval can be initiated after subsequent provisioning steps as needed.

An advantage of the on-device validation 106 is that it allows the pairing process to complete without requiring an active internet connection, making it particularly useful for offline environments or secure installations. However, cloud-hosted configuration data enables rapid versioning, ensuring that devices remain up-to-date without requiring firmware modifications. The cloud-based validation 108 also reduces the memory and storage requirements within the device, allowing manufacturers to optimize hardware resources while maintaining flexibility in device behavior and interactions.

In some instances, security key exchange may also be performed in the earlier validation phase 106 or 108 if the manufacturer of the IoT device 102 configured the IoT device 102 to communicate only with approved client devices. In such scenario, device attestation data may also be exchanged to verify that the IoT device 402 is an original device made by the original manufacturer, not a cloned copy.

### 3. Pairing

After the validation phases 106 and 108, the adaptive interface application enters a pairing phase 110. During the pairing phase 110, the adaptive interface application and the IoT device 102 establish a secure communication channel by exchanging encryption data. Exchange of encryption data prevent eavesdropping and protecting against Man-In-The-Middle attacks, ensuring that data transmitted between the device and the interface remains confidential and tamper-proof. The encryption exchange can involve asymmetric key exchanges, such as Diffie-Hellman or RSA-based methods, or symmetric key generation using protocols like AES, depending on the security architecture of the system.

In addition to securing communication, the adaptive interface application can provide the IoT device 102 with networking credentials to enable network connectivity. Examples may include: (i) transmitting Wi-Fi router passwords to allow the device to connect to a local network; or (ii) provisioning security tokens for authentication with cloud services. For example, when setting up a smart thermostat, the adaptive interface application may securely send Wi-Fi credentials, allowing the smart thermostat to join the network and communicate with cloud-based automation systems. Similarly, a sensor device may receive an authentication token that grants it secure access to the adaptive interface application.

### 4. Handshake

After the pairing phase 110, the adaptive interface application enters a handshake phase 112. At the handshake phase 112, attestation checks can be performed to verify the authenticity of the IoT device 102 and protect against counterfeiting. The handshake phase 112 ensures that only legitimate devices are integrated into the IoT network environment, preventing unauthorized or compromised hardware from gaining access. The attestation check may involve comparing a device's unique identifier, cryptographic signature, or manufacturing details against a cloud-based database maintained by the manufacturer or service provider. The adaptive interface application can perform the verification step by securely querying the database and confirming that the IoT device 102 matches a registered and trusted entry. If the validation fails, the provisioning process may be halted, preventing unauthorized devices from joining the network. As described herein, the attestation checks can be performed during the validation phase 106 or 108, to prevent counterfeit devices from getting too far before getting detected or leaking PII/PHI.

Once the pairing and handshake are successfully completed, the established settings can be stored on the IoT device 102. The settings can enable the IoT device 102 to initiate a more direct, encrypted communication channel with the adaptive interface application, facilitating secure and efficient data exchange without requiring repeated authentication. Future interactions between the device and the application can leverage this stored information, bypassing the need for repeated provisioning steps. However, if the device is reset to factory settings, the entire provisioning process is restarted.

### 5. Update

After the handshake phase 112, the adaptive interface application enters an update phase 114. At the update phase 114, the adaptive interface application can perform a version check to determine whether the IoT device 102 is running the most recent firmware. The version check process can ensure that the device operates with the latest security patches, performance optimizations, and feature updates. The version check can be executed in several ways. The device may directly access the cloud to compare its firmware version against the latest available release. Additionally or alternatively, the adaptive interface application can act as an proxy, querying the cloud on behalf of the device and relaying the information. Another approach involves using the adaptive interface application or a local gateway as a repository for firmware updates, allowing the IoT device 102 to fetch the updates without requiring direct internet access.

When the adaptive interface application or the local gateway serves as a firmware repository, multiple devices of the same type can be updated efficiently without generating redundant network traffic for each individual device. Instead of each device independently downloading the update from the cloud, a single update can be retrieved and distributed locally, reducing bandwidth consumption and improving deployment speed.

### 6. UI Generation

After the update phase 114, the adaptive interface application enters a UI-generation phase 116. At the UI-generation phase 116, the adaptive interface application generates a user interface tailored to the IoT device 102. To generate the user interface, the adaptive interface application can utilize the configuration data obtained from the earlier steps (e.g., the validation phases 106 or 108) or separately contact a computing resource service provider to access the necessary components for generating the user interface. The component access process ensures that a corresponding IoT interface is dynamically constructed based on the device's capabilities. Examples of the components can include interactive control elements such as sliders, toggle switches, buttons, and input fields that allow the user to manipulate the device's functions directly. Other components can include but are not limited to dropdown menus, tabbed views, modal dialogs, voice input prompts, gesture-based controls, QR code scanners, map displays, and real-time notifications.

In some embodiments, the UI components can be identified by using a machine-learning model to process the configuration data. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate narratives. In addition to training the model, various prompts can be used for prompt engineering of the machine-learning model for generating the narratives. Examples of the machine-learning model can include, but are not limited to, BERT model, Claude LLM, Falcon 40B, Ernie, GPT-3, GPT-3.5, GPT 4, Lamda, and Llama.

As an illustrative example, in the case of a smart light switch, the configuration data may define specific attributes that control its functionality. The on/off state is typically represented as a Boolean value, determining whether the switch is currently active or inactive. The dimming value is a numeric range, allowing users to set brightness levels from a minimum to a maximum intensity. If the switch supports color control, the color value might be expressed in RGB format, represented either as a hexadecimal number or a tuple containing red, green, and blue components.

Beyond just defining these attributes, the configuration data can additionally specify how the attributes can be read, modified, and updated in real time. These specifications can be generated in various formats, including REST APIs for web-based control, BLE characteristics for short-range wireless communication, or Matter clusters for interoperable smart home ecosystems. These definitions enable seamless communication between the IoT device 102 and the adaptive interface application.

For each of these attributes, the configuration data can define a standardized set of values and their corresponding representations in the application interface. For instance, a boolean on/off state could be displayed as a toggle switch, a dimming range might be controlled with a slider, and a color selection could be presented as a color picker. These UI elements can be mapped onto UI/UX widgets or flows, enabling intuitive interactions across different control mechanisms such as touch, voice commands, or gesture-based inputs.

In some instances, the configuration data defines the set of actions and operations that the user can perform on the IoT device 102. In the case of a light switch, this might include retrieving the current state, turning it on or off, toggling its status, or adjusting its brightness and color. Additionally or alternatively, role-based access control settings can also be specified by the configuration data, in which the role-based access control setting permit only authorized users or roles to execute certain operations. For example, an administrator may have full control over a lighting system, while a guest user may only have access to basic on/off functionality.

The rules specified in the configuration data allow the adaptive interface application to dynamically generate a range of interaction models tailored to the user's environment. This includes the ability to create aggregated data dashboards that provide an overview of multiple devices and their statuses. Such dashboards can be assembled in real time based on which devices are available to an individual user, presenting a unified and contextualized control interface. In some instances, the rules may also include Boolean logic to control what types of interactions are available to the user given certain pre-conditions. For example, after toggling a checkbox, a different set of interaction options may be made available. Certain actions may only be available if other actions have already been taken. In some instances, a scripting engine may also be embedded in either client application or device side, with scripts exchanged between the two as part of the configuration data. The scripting will be limited to certain secure, sandboxed actions, but allow for more complex, conditional logic. The type, version, and dialect of the scripting system may be negotiated during the discovery phase.

To further enhance device management and customization, the adaptive interface application can be configured to support the downloading of additional code components. These could include scripts for automation, binary modules for extended functionality, or standalone applications designed to refine the user experience. Examples of scripts for automation include scheduling routines that turn devices on or off at specific times, context-aware triggers that activate based on sensor input or user location, and coordinated behaviors across multiple devices in response to defined events. Examples of binary modules for extended functionality include firmware add-ons that enable advanced sensor calibration, support for new communication protocols, integration with third-party services, or enhanced security features such as encrypted data transmission. For instance, a smart lighting system might download a script that synchronizes light colors with ambient music, while a sensor may receive a firmware module to enable new data analysis capabilities.

### 7. UI Calibration

After the UI-generation phase 116, the adaptive interface application enters a UI-calibration phase 118. At the UI-calibration phase 118, the adaptive interface application adjusts the generated user interface to align with local settings of the adaptive interface application, including SmartHome configurations, AbleUI preferences, and personalized settings of individual users. The calibration phase 118 ensures that the generated interface reflects the user's specific IoT network environment as well as the user's physical abilities (e.g., voice control vs. touch), allowing for a more intuitive and seamless interaction with the IoT device 102. Adjustments may include modifying default controls, adjusting display layouts, or incorporating accessibility features based on the user's preferences. In some instances, during the UI-calibration phase 118, the user may be authorized to further modify or change the generated UI based on the user preferences (e.g., changing control layouts, color schemes and themes, languages).

### 8. Save State

Once the calibration phase 118 is complete, the adaptive interface application proceeds to a save state phase 120 to save configured settings to facilitate faster future connections. This data can be stored within the adaptive interface application, a gateway device, or on the IoT device itself. For example, the interface settings can be stored in a mobile application by saving the user's preferred control layout, such as button placements or color themes, or by caching device-specific configurations like network credentials or sensor thresholds. By maintaining these settings locally, the system optimizes performance and reduces setup time for subsequent sessions.

### 9. Publish to Network

After the save state phase 120, the adaptive interface application successfully completes the provisioning process. During a subsequent publish phase 122, the adaptive interface application can publish the device's operation status, along with relevant configuration data, to a local network or a cloud computing environment.

The device information can be published via transmission to a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), RPC, Matter, CANBus, and other such communications protocols.

The publish phase 122 allows other devices within the IoT network environment to discover and connect to the newly provisioned device (i.e., the IoT device 102), enabling direct communication, mesh networking formation, or further local calibrations. For example, other smart home components may automatically subscribe to relevant services provided by the IoT device 102, facilitating interoperability and automation.

### 10. Verification Tests

To ensure that the IoT device 102 is fully operational, the adaptive interface application can perform a series of verification tests (verification test phase 124). These verification tests can be performed by initiating test commands, monitoring real-time responses from the device, and evaluating communication integrity between the device and other components within the IoT network. The adaptive interface application may send control signals to trigger specific device functions—such as reading a sensor value—and then assess whether the expected outcomes occur within acceptable response times.

These end-to-end tests validate that the IoT device 102 has been correctly provisioned and can reliably communicate within the IoT network environment. Examples of verification tests can include but are not limited to confirming connectivity, verifying responsiveness to commands, and ensuring that real-time data updates are properly transmitted and received. If any issues are detected, the adaptive interface application may be prompted for reconfiguration or troubleshooting before proceeding.

### 11. Ready for Interaction

Once the previous provisioning steps are successfully completed, the adaptive interface application deploys the IoT device 102 to the IoT network environment (a deployment phase 126). In some instances, the above process can be executed with minimal to no active user intervention after initially powering on the device. The IoT device 102 can now be operated using the adaptive interface application implemented in a mobile device or a gateway device, using various types of interaction controls that are specifically configured for the operations associated with the IoT device 102.

A particular advantage of the provisioning process is that new devices can be seamlessly integrated into the IoT network environment without requiring manual interface modifications or updates. In addition, an interface can dynamically adapt to the newly introduced device, ensuring compatibility and usability without requiring additional development efforts or software updates. This approach significantly enhances scalability, allowing users to expand their IoT ecosystem effortlessly.

The data generated by the device can be transformed into a standardized stream, enabling seamless integration with other systems for advanced processing. This standardized format ensures compatibility across various applications, allowing the data to be utilized for anomaly detection, the creation of synthetic events, and real-time or historical data analytics. By structuring the data in a consistent manner, systems can efficiently interpret and act upon the information without requiring custom parsing or translation layers.

To further enhance interoperability, events and operators associated with the device's data can be defined within configuration data tables. These structured definitions allow other subsystems to automatically adapt their data pipelines based on the provided configuration data. Rather than requiring a manual rewrite of core processing software, subsystems can dynamically adjust how they process, filter, or analyze incoming data. For example, a monitoring system may detect irregularities in sensor readings and trigger alerts without modifying its underlying analytics engine. Similarly, a smart home automation platform could recognize new device events and incorporate them into its workflow without additional coding. By adopting this configuration-driven approach, the system remains flexible, scalable, and capable of evolving without disrupting existing processes. This ensures that new devices and data sources can be seamlessly integrated into the IoT network environment while maintaining consistency across all connected platforms.

In some instances, the configuration data may also be used to train a machine-learning model, or be made accessible via an interface like Retrieval-Augmented Generation (RAG) system, Model Control Protocol (MCP), or other Application Programming Interfaces like HTTP/HTTPS, REST, or Protobuf.

### B. Methods

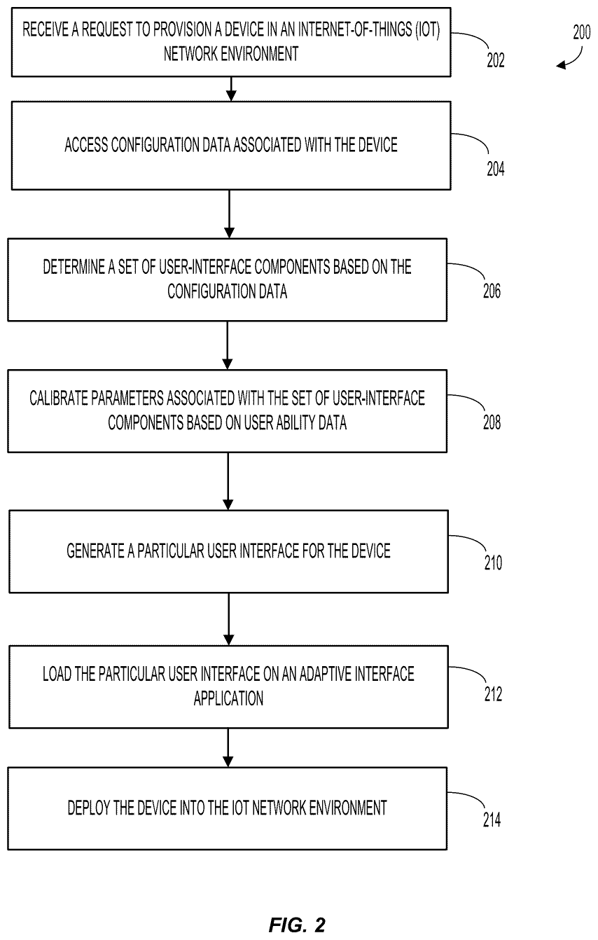

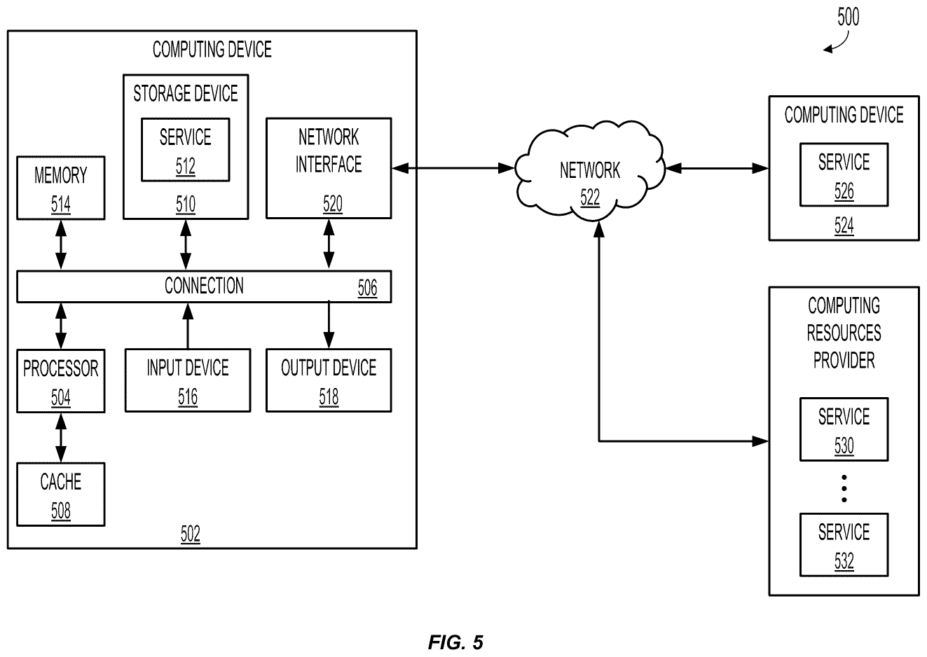

FIG. 2 shows an illustrative example of a process 200 for provisioning IoT devices in an IoT network environment, in accordance with some embodiments. For illustrative purposes, the process 200 is described with reference to the components illustrated in FIG. 1, though other implementations are possible. For example, the program code for the adaptive interface application of FIG. 1, is executed by one or more processing devices to cause a server system (e.g., the computing device 502 of FIG. 5) to perform one or more operations described herein.

At step 202, the adaptive interface application receives a request to provision a device in an Internet-of-Things (IoT) network environment. In some instances, the device is an IoT device. Examples of the device can include, but are not limited to, smart thermostats, connected lighting systems, environmental sensors, security cameras, smart locks, wearable health monitors, home automation hubs, connected appliances, vehicles, transportation mechanisms, accessibility accessories, wearables (health and non-health), entertainment and media devices, medical accessories and systems, cleaning and food preparation, toys, HVAC, security, and any device with sensors or controllable actuators.

At step 204, the adaptive interface application accesses configuration data associated with the device. In some instances, the configuration data includes one or more device attributes indicating how the device operates and interacts within the IoT network environment. The adaptive interface application can additionally validate the device before deploying the device to the IoT network environment. For example, the configuration data can include version information, specifying both the firmware and hardware revisions to ensure compatibility. The configuration data may also define the available modes of communication, such as whether the device supports Bluetooth, Wi-Fi, Zigbee, Thread, Matter, or wired protocols such as Ethernet, RS-232, or CANBus (which may require an interface translator or gateway), or other networking standards. The supported protocols are outlined in the configuration data, indicating whether the device adheres to industry standards like MQTT, HTTP, Protobuf, Matter, or proprietary communication frameworks.

The configuration data can also specify the types of data points the device generates or accepts, such as temperature readings for a smart thermostat or motion detection alerts for a security camera. It includes validation rules and operational limits, ensuring that data inputs and outputs conform to expected ranges. Default values may also be provided, allowing the device to function immediately with preconfigured settings before customization.

Additionally or alternatively, the configuration data can include additional elements such as multimedia files, scripts, or metadata necessary to interact with the device. The configuration data can also identify available endpoints, notifications, and operations, thus defining the device's capabilities for remote control, data retrieval, and event triggers. In some instances, role-based access control settings can also be specified by the configuration data, in which the role-based access control setting permit only authorized users or roles to execute certain operations.

In some instances, two possible pathways can be used for obtaining the configuration data. In a cloud validation phase, a type identifier of the device is securely transmitted to a remote server (e.g., a cloud computing environment), in which configuration data specific to a class associated with the device is retrieved and accessed by the adaptive interface application. In an on-device validation phase, the device is prompted to transmit the same configuration data directly to the adaptive interface application. Such local retrieval can be initiated after subsequent provisioning steps as needed.

At step 206, the adaptive interface application determines a set of user-interface components based on the configuration data. Before determining the set of user-interface components, the adaptive application can pair the device with the adaptive interface application Examples of the components can include interactive control elements such as sliders, toggle switches, buttons, and input fields that allow the user to manipulate the device's functions directly. Other components can include but are not limited to dropdown menus, tabbed views, modal dialogs, voice input prompts, gesture-based controls, QR code scanners, map displays, and real-time notifications.

In some embodiments, the UI components can be identified by using a machine-learning model to process the configuration data. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data, such that the machine-learning model can generate narratives. In addition to training the model, various prompts can be used for prompt engineering of the machine-learning model for generating the narratives. Examples of the machine-learning model can include, but are not limited to, BERT model, Claude LLM, Falcon 40B, Ernie, GPT-3, GPT-3.5, GPT 4, Lamda, and Llama.

At step 208, the adaptive interface application calibrates parameters associated with the set of user-interface components based on user ability data. In some instances, the adaptive interface application adjusts the generated user interface to align with local settings of the adaptive interface application, including SmartHome configurations, AbleUI preferences, and personalized settings of individual users. The calibration step ensures that the generated interface reflects the user's specific IoT network environment as well as the user's physical abilities (e.g., user ability data indicating whether to use voice control over touch), allowing for a more intuitive and seamless interaction with the device. Adjustments may include modifying default controls, adjusting display layouts, or incorporating accessibility features based on the user's preferences. In some instances, during the calibration, the user may be authorized to further modify or change the generated UI based on the user preferences (e.g., changing control layouts, color schemes and themes, languages).

At step 210, the adaptive interface application generates a particular user interface for the device. In some instances, the particular user interface is generated based on the set of user-interface components and calibrated parameters, in which the particular user interface is different from user interfaces associated with other devices within the IoT network environment.

In some instances, the adaptive interface application saves configured settings associated with the particular user interface to facilitate faster future connections. This data can be stored within the adaptive interface application, a gateway device, or on the IoT device itself. For example, the interface settings can be stored in a mobile application by saving the user's preferred control layout, such as button placements or color themes, or by caching device-specific configurations like network credentials or sensor thresholds. By maintaining these settings locally, the system optimizes performance and reduces setup time for subsequent sessions.

At step 212, the adaptive interface application loads the particular user interface on an adaptive interface application. For example, the adaptive interface application applies responsive layout rules and adaptive styling of the particular user interface to optimize for the current screen size, input method, and accessibility settings.

At step 214, the adaptive interface application deploys the device into the IoT network environment. The one or more operations of the device can then be initiated by interacting with the particular user interface of the adaptive interface application. In some instances, the process 200 can be executed with minimal to no active user intervention after initially powering on the device. The adaptive interface application can publish the device's operation status, along with relevant configuration data, to a local network or a cloud computing environment. This allows other devices within the IoT network environment to discover and connect to the newly provisioned device, thereby enabling direct communication, mesh networking formation, or further local calibrations. Process 200 terminates thereafter.

### II. Mapping of Device Capabilities to User Interaction Intents

IoT devices offer an interface for reading and transmitting data, changing values, and firing events, including broadcasts. This section provides different techniques to map each IoT device's list of capabilities, obtained during provisioning in the previous section, and the two-way mapping of user interactions to those capabilities. The mapping mechanism allows devices to be controlled and managed via whatever method is most convenient for the user, while also enabling device automation and the implementation of complex workflows.

For every device, several considerations must be taken into account, including reading state (such as whether a light is on or off), control (such as changing a value or turning something on or off), events (real-world data that may be of interest), and grouping or workflows (clustering multiple devices together in any combination of these operations). For each of these scenarios, mechanisms should be provided that best fit the mode of interaction most convenient to the user.

### A. Computing Environment

### 1. Control State

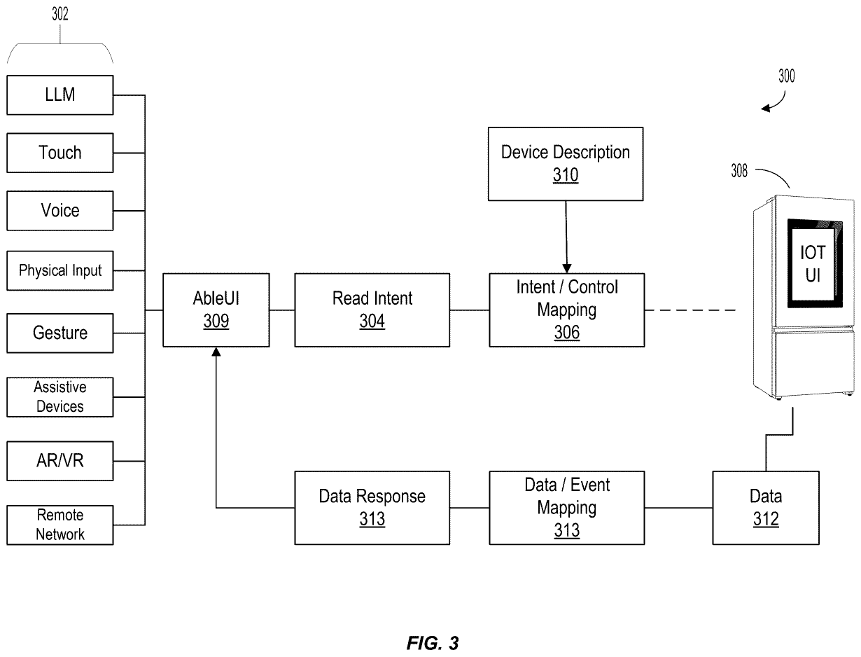

FIG. 3 illustrates a schematic diagram 300 for mapping various types of inputs to operations of IoT devices, according to some embodiments. As shown in FIG. 3, an intent-mapping application can process a plurality of interface inputs 302 from the user into uniform events, which can then be translated into an intent 304. Various types of interfaces inputs can be processed. For example, Large Language Models (LLM) serve as an advanced input method, allowing users to interact with systems through natural language processing, enabling conversational interfaces and intelligent automation. Touch-based input is another method in which the users interact with devices through direct contact with a touchscreen or touch-sensitive surface. Voice input facilitates hands-free operation by allowing users to control systems through spoken commands, enhancing accessibility and convenience in various applications.

Physical input includes traditional input devices such as keyboards, buttons, and switches, which provide tactile feedback and precise control. Gesture-based input leverages motion detection to interpret hand or body movements. Assistive devices are customized and manufactured for users with disabilities by incorporating adaptive technologies such as eye-tracking systems, specialized keyboards, or sip-and-puff devices to facilitate interaction. AR/VR (Augmented Reality/Virtual Reality) utilizes spatial and immersive inputs, allowing users to engage with digital content in a three-dimensional space using headsets, controllers, or hand-tracking technology. Remote network input enables interaction from distant locations, allowing users to control or monitor systems over the internet or other networked environments, ensuring accessibility and functionality beyond physical proximity. The above examples of interface inputs are for illustrative purposes only, and other types of interface inputs can be contemplated by a skilled person.

The intent 304 can identify various characteristics associated with the interface inputs 302, including one or more intended inputs across one or more pages of the application as well as expected outputs triggered in response to the intended inputs. In some instances, the intent includes a list of attributes and a verb/command. Attributes can include parameters or properties associated with the interface inputs 302, including user-provided data, measured ability levels (e.g., vision or hearing impairment), contextual metadata, or system-defined variables that refine the intent's meaning and execution. In addition, a verb/command can represent an action or directive associated with the intent, specifying a type of operation the application should perform. The type of operation can include “send,” “select,” “navigate,” or “confirm.”

In some instances, the interaction-mapping system can extract the intent 304 by processing the interface inputs 302 using an intent-discovery machine-learning model. Examples of the intent-discovery machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the intent-discovery machine-learning model can include, but are not limited to, genetic algorithms, backpropagation, reinforcement learning, decision trees, linear classification, artificial neural networks, anomaly detection, and such. In yet other examples, the intent-discovery machine-learning model may include regression analysis, dimensionality reduction, metalearning, reinforcement learning, deep learning, and other such algorithms and/or methods.

In some instances, the intent-discovery machine-learning model is a transformer model (e.g., a large-language model (LLM)) obtained from a models database. In some instances, the intent-discovery machine-learning model is trained using self-supervised learning based on a large corpus of text data, such that the intent-discovery machine-learning model can generate narratives. In addition to training the model, various prompts can be used for prompt engineering of the intent-discovery machine-learning model for generating the narratives. Examples of the intent-discovery machine-learning model can include, but are not limited to, BERT model, Claude LLM, Falcon 40B, Ernie, GPT-3, GPT-3.5, GPT 4, Lamda, and Llama.

An illustrative example process of training and deploying the transformer model (e.g., a GPT model) is as follows. For the training dataset (e.g., the previous input data and intent 304), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

In some instances, the interaction-mapping system can construct one or more prompts that can be submitted with the interface inputs 302 to enhance and increase the accuracy of the intent 304. As used herein, the term “prompt” can refer to an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used iteratively refine the prompt P to maximize O(P, R), to facilitate the model to consistently produce accurate, relevant, and contextually appropriate outputs (e.g., the intent 304). For example, the optimal prompt P* can be determine based on maximizing the objective function O:

$$P *= arg max O ( P , LM ( P ) ) \qquad Equation ( 1 )$$

Through the iterative refinement process, prompt engineering enhances the corresponding model's performance across various natural language processing tasks, such as generating the intent 304 that are contextually relevant to the interface inputs 302.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

The interaction-mapping system can apply the trained and fine-tuned machine-learning model to the interface inputs 302 to generate the intent 304. To begin the deployment process, the interaction-mapping system can tokenize the merged data into a sequence of text tokens. For example, the merged data can be tokenized to provide the following sequence: [“You”, “are”, “an”, “assistant”, “tasked”, . . . ]. In some instances, the machine-learning model uses Byte Pair Encoding (BPE) techniques to further split a single token (e.g., “in”, “sufficient”).

The interaction-mapping system can assign each token with a particular index value in the vocabulary (e.g., “assistant”=E[5]). Then, the interaction-mapping system can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value looking at a corresponding row of embedding matrix E.

$$E : {e}_{i} = E [ {t}_{i} ] \qquad Equation ( 2 )$$

The interaction-mapping system can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the interaction-mapping system can then determine a contextual representation for each position-encoded vector of the matrix X. In particular, for each position-encoded vector, the interaction-mapping system can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

$$Attention ( Q , K , V ) = soft max ( ( {QK}^{T} ) / √ ( {d}_{k} ) ) V \qquad Equation ( 3 )$$

The (QK^{T})/√(dₖ) can be used to compute the raw attention scores, in which dₖ is the dimensionality of the key vectors. Then, the softmax function is applied to the raw attention score to normalize it into a probability distribution. The interaction-mapping system can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the merged data.

The interaction-mapping system can then apply the machine-learning model to the set of contextual representations to generate the intent 304. In particular, the machine-learning model can process the set of contextual representations to predict each token of the intent 304, in which the output tokens can correspond to the intent 304.

In some instances, the intent 304 is subsequently converted into control actions 306 supported by a device 308. The control actions can be generated for the device by analyzing the user's intent 304 and translating it into specific operational commands based on the device's functional capabilities. This process may involve interpreting input signals, such as voice commands, gestures, or touch interactions, and matching them with predefined control protocols. The adaptive interface application can then format these commands according to the device's supported communication standards, such as sending an HTTP request, issuing a Bluetooth command, or transmitting a message over a local network. In some instances, device capabilities 310 identified during the provisioning process can be used to enable mapping of the intent 304 to the control actions 306 of the device 308. Example implementation for determining device capabilities during the provisioning process as described in FIG. 1 and Section I of the present disclosure.

As an illustrative example, a user sitting in their bedroom may put their thumb and forefinger together and draw a horizontal line. A camera device monitoring the user interactions translates that into a gesture input, which is then processed by a user-interaction system 309 such as AbleUI to convert the gesture input into a “light toggle” intent. Since there is only one lighting device in the current space, the intent is associated with the lighting device and registered as a tuple event: [house, bedroom, light, toggle]. The intent can then be passed to a device (e.g., a gateway device) that maintains a low-level registry of that lamp model, translating the intent into control actions 306, and transmitting it to the lighting device via a wireless communication channel. As a result, the light turns on in response to the gesture.

The same outcome could have been achieved using other types of interface input, including voice control, an assistive device, physical controls on a panel, or even controls on the same device. When the user is not in the same location, the intent 304 can be derived by providing additional context, such as specifying that the event should be directed to the user's primary residence, offices, factories, inside moving vehicles, etc. In some instances, the event could also be made temporarily available in other locations including doctor's offices, hospital rooms, skilled care, rehab facilities, etc. This approach of remote intent derivation could also be integrated with automation systems, including control panels or machine-learning systems.

### 2. Read State

In some instances, the user may interact with the adaptive interface application to identify operational status of a given IoT device. When the user needs to obtain such status, the adaptive interface application can: (i) directly inquire from the device; or (ii) interrogate a digital twin of the device.

Continuing with FIG. 3, a roundtrip signal is transmitted from the user to the device 308, with data payload returning as part of the response. The following diagram illustrates this process. The user generates a request, which is transmitted to the device 308, and the result is returned as a data element 312. This data element 312 can then be translated into a data response 314 that includes a format appropriate for the user's abilities via a user-interaction system 316. In some instances, the request and response paths may not always be identical. For instance, a user may request a status using a gesture but receive the result through generated voice output or a display panel.

In some instances, if a device is turned off or in sleep/low-power mode, retrieving its status may require significant processing or may not be possible at all. In such scenario, if a digital twin of the device is maintained, the information can be retrieved from the twin. A digital twin can be a virtual replica of the device 308 that mirrors the real-time data and behavior of the physical counterpart. The digital twin can be updated using data from sensors, historical information, and predictive models, allowing for continuous monitoring and analysis even when the actual device is inactive. The digital twin can simulate various operational states, including normal functions, potential failures, or degraded performance. While using a digital twin may not reflect the absolute current state of the device, the digital twin can provide the last known status, offering a viable alternative when direct inquiry is impractical.

### 3. Events

Some devices can generate events when there is a matter of interest, such as a thermostat exceeding a threshold or someone pressing a doorbell. In those instances, the device 308 may transmit a device event to a mechanism such as a gateway device in the IoT network environment to relay relaying the event for processing. Depending on the device's capabilities 310, the initial event processing may occur on the device 308 or be transmitted to a controlling mechanism with storage and processing capabilities.

The event can identify a wide range of activities and incidents, from routine health check events such as heart rate monitoring to critical alerts such as falls or emergency button activations. Other activities or routines identified by the event can include but are not limited to daily activities such as eating, showering, and going for a walk, etc., which may also be indicators of whether someone's patterns of activity have worsened.

In some instances, the event can be a raw event or a synthetic event. The raw event can be an initial, unprocessed data measured or recorded for the subject. The raw event can include a wide range of data points, such as clinical measurements performed by healthcare providers, diagnostic results from lab tests, imaging studies, administered treatments, types of surgeries performed, adverse events (e.g., side effects). The raw event can also include ambient environmental data as well as from sensors worn on body, embedded, or smart-home nodes. In some instances, the raw event includes events reported by the subject, in which the subject describes his or her symptoms, quality of life, or other health-related issues. In addition, the raw event can include physiological parameters (e.g., weight, blood pressure) of the subject using one or more medical devices, including sensors. Raw events can be collected in real-time and may quickly provide meaningful information regarding the subject. On the other hand, the raw events can include errors, inconsistencies, or redundancies that may need to be further processed before the raw event can be used for analysis or reporting purposes.

For example, once the event has been identified, it can be converted into a synthetic event by combining it with additional context, such as user-specific data, time, or location information, or by analyzing it in relation to events or data from other devices. Body temperature, sound, and a user's location can be combined to derive a more meaningful synthetic event.

When a threshold event is reached, the same process as a READ event is followed, where the data element 316, mapped as an unsolicited data response (steps 313-314), and communicated to the user through a type of user-interface output best suited to their abilities. Various types of user-interface output can be used, depending on the user's preferences and accessibility needs. For instance, haptic feedback could provide physical sensations, such as vibration, to alert the user of the event, making it particularly useful for individuals with visual or auditory impairments. Visual cues, like flashing lights or color changes, could also be employed for those who rely on visual stimuli. In addition, auditory feedback, such as beeps, tones, or voice prompts, could be used for users who have difficulty seeing or interacting with visual elements. These different types of outputs ensure that the information is effectively conveyed to the user in a manner that is accessible and intuitive for their specific needs.

For instance, if someone rings a doorbell, the data tuple [house, front door, doorbell, toggle] is mapped into a Doorbell Ring event. This event is then sent to the user-interaction system 309, where it can be translated into a voice announcement, a light activation, or an indicator within a mobile app.

In some instances, the same intents—whether requested by the user or triggered by a device event—can initiate a sequence of operations. The sequence of operations can enable a complex workflow that involves multiple devices within the IoT network environment. For example, if a user waves their hand in a “bye-bye” gesture, the system may detect that the bed sensor is triggered, indicating that the user is in bed. This intent is then translated into a workflow event that turns off the house lights, sets the temperature to 64 degrees, locks the front door, and activates the alarm. These actions are iterations of the previously described sequences, combining Control, Read, and Event mechanisms described herein.

### B. Methods

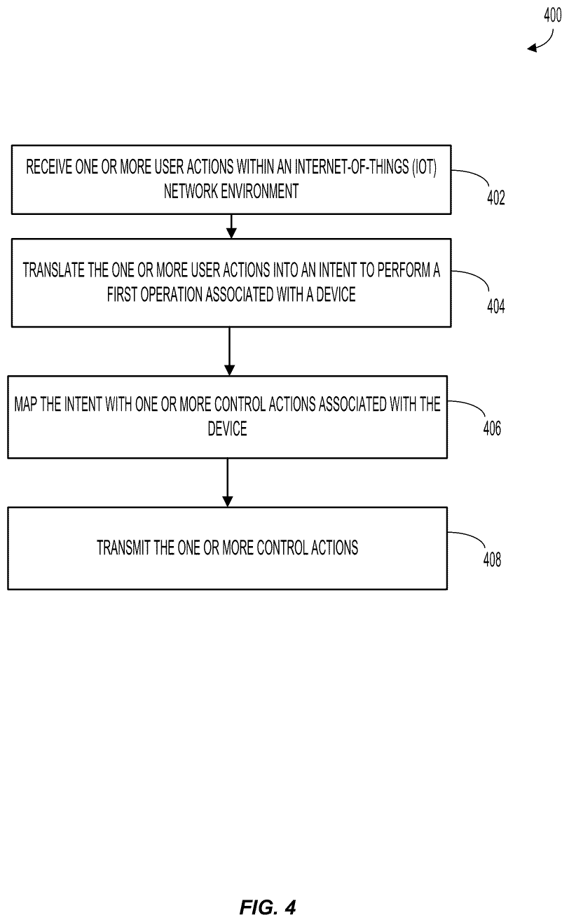

FIG. 4 shows an illustrative example of a process 400 for mapping various types of inputs to operations of IoT devices, in accordance with some embodiments. For illustrative purposes, the process 400 is described with reference to the components illustrated in FIG. 3, though other implementations are possible. For example, the program code for the interaction-mapping system of FIG. 3, is executed by one or more processing devices to cause a server system (e.g., the computing device 502 of FIG. 5) to perform one or more operations described herein.

At step 402, the interaction-mapping system receives one or more user actions within an Internet-of-Things (IoT) network environment. The one or more actions can be associated with a type of interface input. Various types of interfaces inputs can be considered. For example, Large Language Models (LLM) serve as an advanced input method, allowing users to interact with systems through natural language processing, enabling conversational interfaces and intelligent automation. Touch-based input is another method in which the users interact with devices through direct contact with a touchscreen or touch-sensitive surface. Voice input facilitates hands-free operation by allowing users to control systems through spoken commands, enhancing accessibility and convenience in various applications.

Physical input includes traditional input devices such as keyboards, buttons, and switches, which provide tactile feedback and precise control. Gesture-based input leverages motion detection to interpret hand or body movements. Assistive devices are customized and manufactured for users with disabilities by incorporating adaptive technologies such as eye-tracking systems, specialized keyboards, or sip-and-puff devices to facilitate interaction. AR/VR (Augmented Reality/Virtual Reality) utilizes spatial and immersive inputs, allowing users to engage with digital content in a three-dimensional space using headsets, controllers, or hand-tracking technology. Remote network input enables interaction from distant locations, allowing users to control or monitor systems over the internet or other networked environments, ensuring accessibility and functionality beyond physical proximity. The above examples of interface inputs are for illustrative purposes only, and other types of interface inputs can be contemplated by a skilled person.

At step 404, the interaction-mapping system translates the one or more user actions into an intent to perform a first operation associated with a device. The intent can identify various characteristics associated with the interface inputs, including one or more intended inputs across one or more pages of the application as well as expected outputs triggered in response to the intended inputs. In some instances, the intent includes a list of attributes and a verb/command. Attributes can include parameters or properties associated with a user associated with the one or more actions, including user-provided data, measured ability levels (e.g., vision or hearing impairment), contextual metadata, or system-defined variables that refine the intent's meaning and execution. In addition, a verb/command can represent an action or directive associated with the intent, specifying a type of operation the application should perform.

In some instances, the interaction-mapping system can identify the intent by applying an intent-discovery machine-learning model to user data identifying the one or more actions. Examples of the intent-discovery machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the intent-discovery machine-learning model can include, but are not limited to, genetic algorithms, backpropagation, reinforcement learning, decision trees, linear classification, artificial neural networks, anomaly detection, and such. In yet other examples, the intent-discovery machine-learning model may include regression analysis, dimensionality reduction, metalearning, reinforcement learning, deep learning, and other such algorithms and/or methods.

In some instances, the intent-discovery machine-learning model is a transformer model (e.g., a large-language model (LLM)) obtained from a models database. In some instances, the intent-discovery machine-learning model is trained using self-supervised learning based on a large corpus of text data, such that the intent-discovery machine-learning model can generate narratives. In addition to training the model, various prompts can be used for prompt engineering of the intent-discovery machine-learning model for generating the narratives. Examples of the intent-discovery machine-learning model can include, but are not limited to, BERT model, Claude LLM, Falcon 40B, Ernie, GPT-3, GPT-3.5, GPT 4, Lamda, and Llama.

At step 406, the interaction-mapping system maps the intent with one or more control actions associated with the device. The control actions can be generated for the device by analyzing the intent and translating it into specific operational commands based on the device's functional capabilities. This process may involve interpreting input signals, such as voice commands, gestures, or touch interactions, and matching them with predefined control protocols. The adaptive interface application can then format these commands according to the device's supported communication standards, such as sending an HTTP request, issuing a Bluetooth command, or transmitting a message over a local network. In some instances, device capabilities identified during the provisioning of the device into the IoT network environment (e.g., the process 200 of FIG. 2) can be used to enable mapping of the intent to the control actions of the device.

At step 408, the interaction-mapping system transmits the one or more control actions to the device. In response to receiving the one or more control actions, the device performs the one or more control actions. As an illustrative example, a user sitting in their bedroom may put their thumb and forefinger together and draw a horizontal line. A camera device monitoring the user interactions translates that into a gesture input, which is then processed by a user-interaction system to convert the gesture input into a “light toggle” intent. Since there is only one lighting device in the current space, the intent is associated with the lighting device and registered as a tuple event: [house, bedroom, light, toggle]. The intent can then be passed to a device (e.g., a gateway device) that maintains a low-level registry of that lamp model, translating the intent into control actions, and transmitting it to the lighting device via a wireless communication channel. As a result, the lighting device turns on the light in response to the gesture. Process 400 terminates thereafter.

### III. Example Systems

FIG. 5 illustrates a computing system architecture 500, including various components in electrical communication with each other, in accordance with some embodiments. The example computing system architecture 500 illustrated in FIG. 5 includes a computing device 502, which has various components in electrical communication with each other using a connection 506, such as a bus, in accordance with some implementations. The example computing system architecture 500 includes a processing unit 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The system architecture 500 can copy data from the memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The memory 514 may be referred to herein as system memory or computer system memory. The memory 514 may include, at various times, elements of an operating system, one or more applications, data associated with the operating system or the one or more applications, or other such data associated with the computing device 502.

Other system memory 514 can be available for use as well. The memory 514 can include multiple different types of memory with different performance characteristics. The processor 504 can include any general purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

In some embodiments, the processor 504 can include multiple elements such as a core, one or more registers, and one or more processing units such as arithmetic logic units (ALU), floating point units (FPU), graphics processing units (GPU), physics processing units (PPU), neural processing units (NPU), tensor processing units (TPU), digital system processing (DSP) units, or combinations of these and/or other such processing units. The processor 804 can be implemented through different processor architectures, such as Reduced Instruction Set Computing (RISC) architectures (e.g., RISC-V, etc.), Advanced RISC Machine (ARM) architectures, and the like.

To enable user interaction with the computing system architecture 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device 502 using the system connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, memory 514, input device 516, output device 518, and so forth, can carry out the functions such as those described herein.

The disclosed systems and service of an adaptive interface application (e.g., the adaptive interface application described herein at least in connection with FIG. 1) can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems associated with the adaptive interface application (e.g., the adaptive interface application described herein at least in connection with FIG. 1) described herein by, for example, executing code using a processor such as processor 504 wherein the code is stored in memory such as memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, ARM or RISC-V microprocessors, or other such microprocessors. One of skill in the relevant art will recognize that the terms “machine-readable (storage) medium” or “computer-readable (storage) medium” include any type of device that is accessible by the processor.

The memory 514 can be coupled to the processor 504 by, for example, a connector such as connector 506, or a bus. As used herein, a connector or bus such as connector 506 is a communications system that transfers data between components within the computing device 502 and may, in some embodiments, be used to transfer data between computing devices. The connector 506 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 514 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 514 can also include magnetic or optical data storage media including read-only (e.g., CD ROM and DVD ROM) or otherwise (e.g., CD or DVD). The memory can be local, remote, or distributed.

As described above, the connector 506 (or bus) can also couple the processor 504 to the storage device 510, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, Android/AOSP, etc.), and real-time operating systems (e.g., VxWorks®, QNX®, eCos®, RTLinux®, etc.) may be considered as within the scope of the present disclosure. As may be contemplated, the names of operating systems, mobile operating systems, embedded systems such as FreeRTOS, Zephyr, and Arduino, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), RPC, Matter, CANBus, and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), Protobuf, MsgPack, BSON, and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™, Ruby, Perl® and variants, Java®, HTML, XML, C, C++, Lua, Swift, Kotlin, or another such server-side processing language.

In some embodiments, the computing device 502 and/or the computing device 524 can be connected to a computing resources provider 528 via the network 522 using a network interface such as those described herein (e.g. network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 200 of FIG. 2). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
receiving a request to provision a device in an Internet-of-Things (IoT) network environment;
accessing configuration data associated with the device, wherein the configuration data includes one or more device attributes indicating how the device operates and interacts within the IoT network environment;
determining a set of user-interface components based on the configuration data;
calibrating parameters associated with the set of user-interface components based on user ability data;
generating a particular user interface for the device, wherein the particular user interface is generated based on the set of user-interface components and calibrated parameters, and wherein the particular user interface is different from user interfaces associated with other devices within the IoT network environment;
loading the particular user interface on an adaptive interface application; and
deploying the device into the IoT network environment, wherein one or more operations of the device are initiated by interacting with the particular user interface of the adaptive interface application.

2. The computer-implemented method of claim 1, wherein accessing the configuration data includes validating the device before deployment to the IoT network environment.

3. The computer-implemented method of claim 1, further comprising pairing the device with the adaptive interface application.

4. The computer-implemented method of claim 1, wherein the configuration data includes role-based access settings, and wherein the particular user interface is configured to be accessed only by users authorized according to the role-based access settings.

5. The computer-implemented method of claim 1, wherein the one or more device attributes identify a type of user-interface inputs associated with the device, and wherein the one or more operations of the device are initiated by performing the type of user-interface inputs.

6. The computer-implemented method of claim 1, wherein deploying the device into the IoT network environment includes publishing one or more device attributes in the IoT network environment.

7. The computer-implemented method of claim 1, wherein steps of determining, calibrating, generating, loading, and deploying are performed without user intervention.

8. A system comprising:
one or more processors; and
memory storing thereon instructions that, as a result of being executed by the one or more processors, cause the system to perform operations comprising:
receiving a request to provision a device in an Internet-of-Things (IoT) network environment;
accessing configuration data associated with the device, wherein the configuration data includes one or more device attributes indicating how the device operates and interacts within the IoT network environment;
determining a set of user-interface components based on the configuration data;
calibrating parameters associated with the set of user-interface components based on user ability data;
generating a particular user interface for the device, wherein the particular user interface is generated based on the set of user-interface components and calibrated parameters, and wherein the particular user interface is different from user interfaces associated with other devices within the IoT network environment;
loading the particular user interface on an adaptive interface application; and
deploying the device into the IoT network environment, wherein one or more operations of the device are initiated by interacting with the particular user interface of the adaptive interface application.

9. The system of claim 8, wherein accessing the configuration data includes validating the device before deployment to the IoT network environment.

10. The system of claim 8, wherein the instructions further cause the system to perform operations comprising pairing the device with the adaptive interface application.

11. The system of claim 8, wherein the configuration data includes role-based access settings, and wherein the particular user interface is configured to be accessed only by users authorized according to the role-based access settings.

12. The system of claim 8, wherein the one or more device attributes identify a type of user-interface inputs associated with the device, and wherein the one or more operations of the device are initiated by performing the type of user-interface inputs.

13. The system of claim 8, wherein deploying the device into the IoT network environment includes publishing one or more device attributes in the IoT network environment.

14. The system of claim 8, wherein steps of determining, calibrating, generating, loading, and deploying are performed without user intervention.

15. A non-transitory, computer-readable storage medium storing thereon executable instructions that, as a result of being executed by one or more processors of a computer system, cause the computer system to perform operations comprising:
receiving a request to provision a device in an Internet-of-Things (IoT) network environment;
accessing configuration data associated with the device, wherein the configuration data includes one or more device attributes indicating how the device operates and interacts within the IoT network environment;
determining a set of user-interface components based on the configuration data;
calibrating parameters associated with the set of user-interface components based on user ability data;
generating a particular user interface for the device, wherein the particular user interface is generated based on the set of user-interface components and calibrated parameters, and wherein the particular user interface is different from user interfaces associated with other devices within the IoT network environment;
loading the particular user interface on an adaptive interface application; and
deploying the device into the IoT network environment, wherein one or more operations of the device are initiated by interacting with the particular user interface of the adaptive interface application.

16. The non-transitory, computer-readable storage medium of claim 15, wherein accessing the configuration data includes validating the device before deployment to the IoT network environment.

17. The non-transitory, computer-readable storage medium of claim 15, wherein the instructions further cause the computer system to perform operations comprising pairing the device with the adaptive interface application.

18. The non-transitory, computer-readable storage medium of claim 15, wherein the configuration data includes role-based access settings, and wherein the particular user interface is configured to be accessed only by users authorized according to the role-based access settings.

19. The non-transitory, computer-readable storage medium of claim 15, wherein the one or more device attributes identify a type of user-interface inputs associated with the device, and wherein the one or more operations of the device are initiated by performing the type of user-interface inputs.

20. The non-transitory, computer-readable storage medium of claim 15, wherein deploying the device into the IoT network environment includes publishing one or more device attributes in the IoT network environment.

21. The non-transitory, computer-readable storage medium of claim 15, wherein steps of determining, calibrating, generating, loading, and deploying are performed without user intervention.
